(19) United States
(12) Patent Application Publication
(10) Pub. No.: US 2013/0040146 A1
(43) Pub. Date: Feb. 14, 2013

(54) GRAPHENE STRUCTURE AND RODUCTION METHOD THEREOF

(71) Applicants: Nozomi Kimura, Kanagawa (JP); Toshiyuki Kobayashi, Kanagawa (JP); Daisuke Hobara, Kanagawa (JP); Masashi Bando, Kanagawa (JP); Keisuke Shimizu, Kanagawa (JP); Koji Kadono, Tokyo (JP)

(72) Inventors: Nozomi Kimura, Kanagawa (JP); Toshiyuki Kobayashi, Kanagawa (JP); Daisuke Hobara, Kanagawa (JP); Masashi Bando, Kanagawa (JP); Keisuke Shimizu, Kanagawa (JP); Koji Kadono, Tokyo (JP)

(73) Assignee: SONY CORPORATION, Tokyo (JP)

(21) Appl. No.: 13/564,571

(22) Filed: Aug. 1, 2012

(30) Foreign Application Priority Data
Aug. 9, 2011 (JP) 2011-173698

(51) Int. Cl. H01B 1/04; B32B 37/02; B32B 9/00; B82Y 30/00

(52) U.S. Cl. 428/408; 252/502; 156/280; 977/734

(57) ABSTRACT

A graphene structure includes a substrate and a graphene layer. The grapheme layer is laminated on the substrate, is formed of graphene doped with a dopant, and has a similar oxidation-reduction potential to that of water.

### CROSS REFERENCES TO RELATED APPLICATIONS

The present application claims priority to Japanese Priority Patent Application JP 2011-173698 filed in the Japan Patent Office on Aug. 9, 2011, the entire content of which is hereby incorporated by reference.

### BACKGROUND

The present disclosure relates to a graphene structure used as an electrode material or the like, and a production method thereof

Graphene is a sheet-like material made of carbon atoms arranged in a hexagonal grid structure and is attracting attention as an electrode material or the like of a touch panel, a solar battery, or the like, because of its conductivity and optical transparency. Here, in recent years, it has been found that it is possible to increase a carrier concentration of graphene and reduce electrical resistance (increase conductivity) of graphene by doping the graphene with a dopant.

However, there is a problem that the carrier concentration of graphene is gradually reduced (resistance gradually increases) with an elapse of time in the case where the carrier concentration of graphene is equal to or larger than a certain value due to doping, although the conduction characteristic of undoped graphene is stable regardless of time. For example, since the conduction characteristic of a device using graphene changes with an elapse of time, it causes a problem in terms of accuracy or the like.

To solve such a problem, for example, “Layer-by-Layer Doping of Few-Layer Graphene Film” by Fethullah Gunes et al., ACS Nano, Jul. 27, 2010, Vol.4, No.8, pp4595-4600 (hereinafter referred to as Non-Patent Document 1) discloses a technique of suppressing a time degradation of a conduction characteristic by inserting a dopant between layers of multilayer graphene (graphene laminated with a plurality of layers of single-layer graphene).

### SUMMARY

However, in the technique described in Non-Patent Document 1, there has been a problem that the suppressive effect of the time degradation of the conduction characteristic is small and the optical transparency is lower than that in the case where single-layer graphene is used because the technique uses multilayer graphene.

In view of the circumstances as described above, there is a need for a graphene structure that is capable of suppressing a time degradation of a conduction characteristic of doped graphene and a production method thereof

According to an embodiment of the present disclosure, there is provided a graphene structure including a substrate and a graphene layer.

The graphene layer is formed of graphene doped with a dopant and laminated on the substrate, and has a similar oxidation-reduction potential to that of water.

According to this configuration, since the graphene layer has a similar oxidation-reduction potential to that of water, water in an environment does not donate an electron to the graphene. Therefore, it is possible to prevent the time degradation of the conduction characteristic of the graphene layer due to the electron donation to the graphene by the water in environment.

The graphene structure may further include a contact layer that is formed of a material having a similar oxidation-reduction potential to that of water and comes into contact with the graphene layer.

According to this configuration, the graphene layer may have a similar oxidation-reduction potential to that of water owing to the contact layer.

The graphene layer may have a carrier concentration that is equal to or lower than 6×10¹³/cm².

When the carrier concentration of the graphene falls within this range, the graphene layer may have a similar oxidation-reduction potential to that of water.

The graphene layer may have a carrier concentration that is equal to or larger than 4×10¹³/cm² and equal to or lower than 6×10¹³/cm².

When the carrier concentration of the graphene falls within this range, the graphene layer may have a similar oxidation-reduction potential to that of water.

The graphene layer may have a carrier concentration that is equal to or larger than 4.5×10¹³/cm² and equal to or lower than 5.5×10¹³/cm².

When the carrier concentration of the graphene falls within this range, the graphene layer may have a similar oxidation-reduction potential to that of water.

According to an embodiment of the present disclosure, there is provided a method of producing a graphene structure, including: laminating a graphene layer formed of graphene on a substrate; doping the graphene with a dopant; and adjusting an oxidation-reduction potential of the graphene layer to a similar level to that of water.

According to this configuration, it is possible to form a graphene structure which has a similar oxidation-reduction potential to that of water.

The adjusting an oxidation-reduction potential of the graphene layer may include aging the graphene layer in a water-vapor atmosphere.

According to this configuration, the graphene layer may have a similar oxidation-reduction potential to that of water.

The adjusting an oxidation-reduction potential of the graphene layer may include laminating on the graphene layer a contact layer which includes a material having a similar oxidation-reduction potential to that of water.

According to this configuration, the graphene layer may have a similar oxidation-reduction potential to that of water.

As described above, according to the embodiments of the present disclosure, it is possible to provide a graphene structure which is capable of suppressing a time degradation of a conduction characteristic of doped graphene and a production method thereof

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a schematic diagram showing a configuration of a graphene structure according to a first embodiment of the present disclosure;

FIG. 2 is another schematic diagram showing a configuration of the graphene structure according to the first embodiment of the present disclosure;

FIG. 3 is still another schematic diagram showing a configuration of the graphene structure according to the first embodiment of the present disclosure;

FIGS. 4A to 4C are band diagrams showing a graphene structure according to a comparison;

FIGS. 5A and 5B are schematic diagrams showing a production process of the graphene structure according to the first embodiment of the present disclosure;

FIG. 6 is a schematic diagram showing a configuration of a graphene structure according to a second embodiment of the present disclosure;

FIG. 7 is a schematic diagram showing a configuration of a graphene structure according to a third embodiment of the present disclosure; and

FIG. 8 is a graph showing a relationship between a carrier concentration and a concentration of gold chloride in a production method of the graphene structure according to the third embodiment of the present disclosure.

### DETAILED DESCRIPTION

Hereinafter, embodiments of the present disclosure will be described with reference to the drawings.

### First Embodiment

A graphene structure according to a first embodiment of the present disclosure will be described.

(Configuration of Graphene Structure)

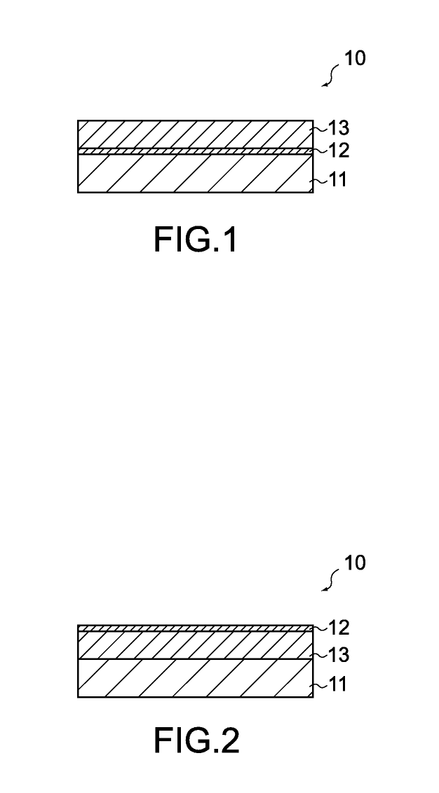

FIG. 1 is a schematic diagram showing a layer construction of a graphene structure 10 according to this embodiment. As shown in this figure, the graphene structure 10 is formed by laminating a substrate 11, a graphene layer 12, and a contact layer 13 in the stated order.

The substrate 11 is a supporting substrate of the graphene structure 10. The material of the substrate 11 is not particularly limited and may be a quartz substrate, for example. If the graphene structure 10 is expected to have optical transparency, the substrate 11 may be formed of a material having optical transparency.

The graphene layer 12 is formed of graphene. Graphene is a sheet-like material made of sp²-bonded carbon atoms arranged in a planar hexagonal grid structure. The graphene may be unlaminated single-layer graphene or multilayer graphene laminated with a plurality of layers of single-layer graphene. In this embodiment, although the graphene is not limited to the above, the single-layer graphene is favorable in terms of the optical transparency of the graphene structure 10 and because no delamination is caused.

The graphene layer 12 is doped with a dopant. The dopant can be selected from a group consisting of, for example, nitric acid, TFSA (trifluoromethanesulfonate), gold chloride, palladium chloride, ferric chloride, silver chloride, platinum chloride, and gold iodide. The doping may be a chemical doping in which the graphene is coated with the dopant by spin coating or the like and the dopant is chemically adsorbed to the graphene.

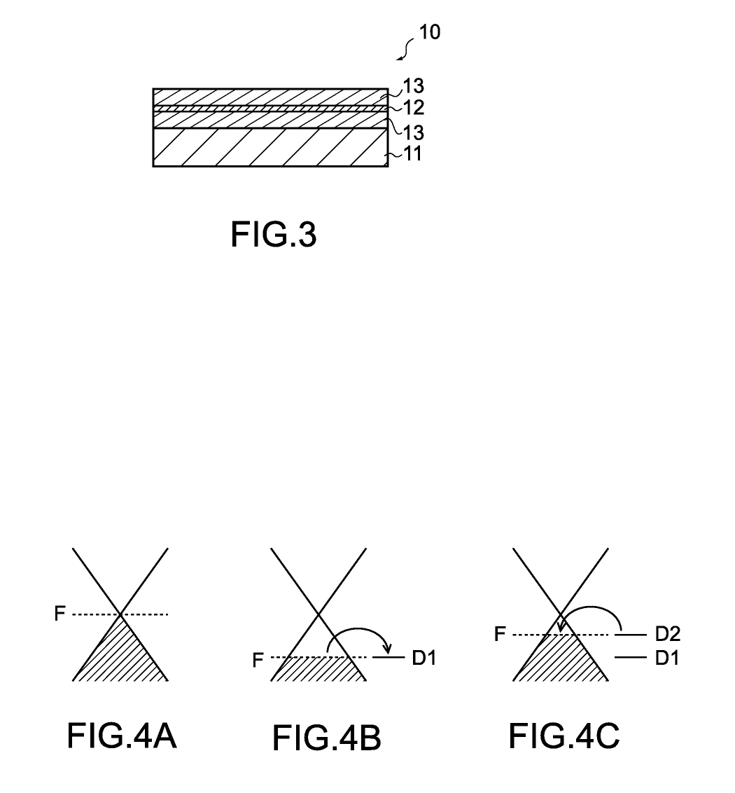

The contact layer 13 is formed of a material having a similar oxidation-reduction potential to that of water and comes into contact with the graphene layer 12. The material having a similar oxidation-reduction potential to that of water may be a general organic material which is neither an oxidizing agent nor a reducing agent. Specifically, a UV (ultraviolet) curable hard coating material, various resin substrates, a UV curable resin (adhesive), a pressure-sensitive adhesive, or the like is used as the material. The contact layer 13 is not limited to be laminated on the upper layer of the graphene layer 12 (on the opposite side of the substrate 11) as shown in FIG. 1. For example, the contact layer 13 may be laminated on the lower layer of the graphene layer 12 (on the side of the substrate 11) as shown in FIG. 2. Alternatively, the upper contact layer 13 and the lower contact layer 13 may be laminated so that the graphene layer 12 is sandwiched between them as shown in FIG. 3. In other words, the contact layer 13 only needs to come into contact with the graphene layer 12 and so it may be laminated on both or one of the upper layer and the lower layer of the graphene layer 12.

Owing to the contact layer 13, the graphene layer 12 has a similar oxidation-reduction potential to that of water and a time degradation of a conduction characteristic of the graphene layer 12 is prevented, although the reason will be described later. It should be noted that, if the substrate 11 is a resin substrate or an adhesive binder layer is used in transferring the graphene layer 12, they may be used as the contact layer 13. Moreover, if the graphene structure 10 is expected to have optical transparency, the contact layer 13 may be formed of a material having optical transparency.

The graphene structure 10 according to this embodiment is formed as described above. The graphene structure 10 can be used as an electrode of a touch panel, a solar battery, or the like.

(Regarding Time Degradation of Conduction Characteristic)

The prevention of the time degradation of the conduction characteristic of the graphene structure 10 will be described. By way of comparison, a graphene structure which has no configuration corresponding to the contact layer 13 (hereinafter referred to as “graphene structure according to a comparison”) will be described.

FIGS. 4A to 4C are band diagrams of the graphene structure according to the comparison. In these figures, an ordinate axis represents an energy level and the dashed line F represents the Fermi level (an energy level with 50% chance of being occupied by an electron) of graphene. Electrons are filled below the Fermi level and the abundance of electrons near the Fermi level corresponds to a carrier concentration.

FIG. 4A shows a state of (undoped) graphene in a vacuum environment. In a case where graphene in this state is chemically doped with a dopant, graphene donates an electron to the dopant until the Fermi level F of graphene coincides with the oxidation-reduction potential D1 of the dopant, as shown in FIG. 4B.

Although it is ideal to maintain this state, that is not what happens actually. As shown in FIG. 4C, water in an environment acts as an electron donor and the Fermi level of graphene increases up to the oxidation-reduction potential D2 of the water and the dopant with an elapse of time. As a result, the carrier concentration of graphene is decreased, so the conductivity of graphene is reduced. The inventors of the present disclosure experimentally found that water in an environment acts as an electron donor, in other words, the time degradation of the conduction characteristic of doped graphene is caused by water in an environment.

As described above, since the time degradation of the conduction characteristic is caused by water in an environment, it becomes possible to suppress the time degradation of the conduction characteristic, if water (including water in the liquid and gas phases) is prevented from donating an electron to graphene. In the graphene structure 10 according to this embodiment, the graphene layer 12 has a similar oxidation-reduction potential to that of water, so the water is prevented from donating an electron to the graphene. It thus becomes possible to prevent the time degradation of the conduction characteristic of the graphene layer 12.

(Production Method of Graphene Structure)

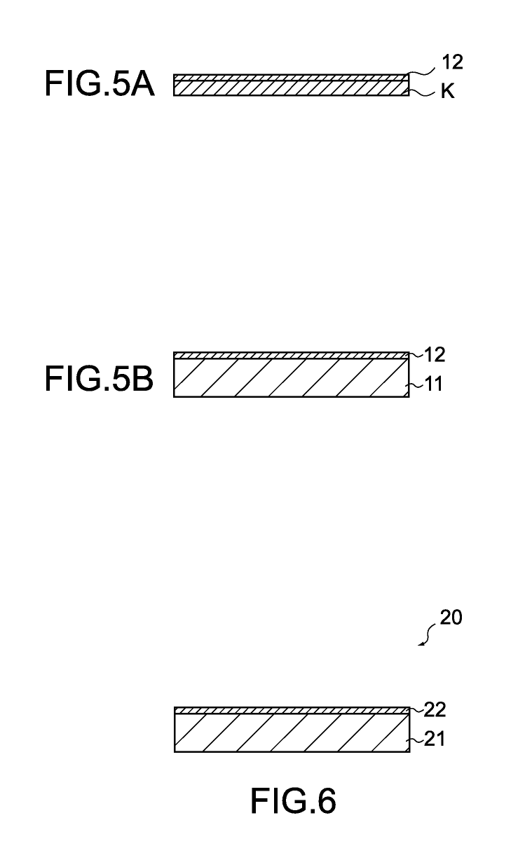

A production method of the graphene structure 10 will be described. FIGS. 5 are schematic diagrams showing the production method of the graphene structure 10 shown in FIG. 1.

As shown in FIG. 5A, a film of graphene is formed on a catalyst substrate K to provide a graphene layer 12. This film formation is performed by using a thermal CVD (Chemical Vapor Deposition) method, a plasma CVD method, or the like. In the thermal CVD method, a carbon source material (material including a carbon atom) supplied to the surface of the catalyst substrate K is heated to form graphene. In the plasma CVD method, a carbon source material is turned into plasma to form graphene. Moreover, graphene released in a solution or graphene physically released may be used, other than the CVD methods. It should be noted that the CVD methods are favorable in terms of the control of the number of layers (transparency), the crystalline (conductivity), the area which is allowed to be formed as a uniform film, and the like.

The material of the catalyst substrate K is not particularly limited, and nickel, iron, copper, or the like may be used as the material. It is favorable to use copper as the material of the catalyst substrate K, because this forms single-layer graphene having high adhesion. It is possible to form a film of graphene on the surface of the catalyst substrate K by supplying a carbon source material (e.g., methane) on the surface of the catalyst substrate K and heating the catalyst substrate K to a temperature equal to or higher than a graphene formation temperature. Specifically, it is possible to cause the graphene to grow by heating the catalyst substrate K to 960° C. and maintaining it for 10 minutes in a mixed gas atmosphere containing methane and hydrogen (for the reduction of the catalyst substrate K, methane:hydrogen=100 cc:5 cc).

Next, as shown in FIG. 5B, the graphene layer 12 is transferred onto an arbitrary substrate 11. Although the transferring method is not particularly limited, the method may be as follows. That is, a 4% PMMA (Poly(methyl methacrylate)) solution is applied onto the graphene layer 12 by spin coating (2,000 rpm, 40 seconds) and is baked at 130° C. for 5 minutes. Accordingly, a resin layer including PMMA is formed on the graphene layer 12. Next, the catalyst substrate K is etched (removed) by using a 1M ferric chloride solution.

After the graphene layer 12 on the resin layer is washed with ultrapure water, the graphene layer 12 is transferred onto the substrate 11 (e.g., a quartz substrate) to be dried naturally. After drying, PMMA is decomposed (removed) by heating (annealing) in a hydrogen atmosphere at 400° C. Accordingly, the graphene layer 12 is transferred onto the substrate 11. Other transferring methods include a method that uses an adhesive and a method that uses a thermal release tape, for example.

Next, graphene which forms the graphene layer 12 is doped. This can be achieved by the method as follows, for example. Specifically, gold chloride is dried in a vacuum at room temperature for 4 hours. By dissolving it into a solvent (e.g., dehydrated nitromethane), a 10 mM solution (hereinafter referred to as dopant solution) is obtained. The dopant solution is applied onto the graphene layer 12 by spin coating (2,000 rpm, 40 seconds) and dried in a vacuum. Accordingly, the graphene is doped.

Furthermore, although the concentration of the dopant in the dopant solution may be selected as appropriate, the light transmission of the graphene layer 12 is reduced when the concentration is too high, and the degradation of the resistance is likely to be caused after the doping when the concentration is too low.

Next, the contact layer 13 is laminated on the graphene layer 12 (see FIG. 1). A solution including the material of the contact layer 13 is applied onto the graphene layer 12 by spin coating (4,000 rpm, 40 seconds) and dried, for example. Accordingly, the contact layer 13 can be formed. The material of the contact layer 13 may be a UV curable hard coating material, for example.

The graphene structure 10 shown in FIG. 1 can be produced as described above. It should be noted that the graphene structure 10 shown in FIGS. 2 and 3 can be formed by changing the order of the graphene layer 12 and the contact layer 13, for example.

(Effect of Graphene Structure)

As described above, by the doping of the graphene layer 12, the resistance of the graphene layer 12 can be reduced in the graphene structure 10 according to this embodiment. Furthermore, it is possible to prevent the time degradation of the conduction characteristic of the graphene layer 12, because the graphene layer 12 has a similar oxidation-reduction potential to that of water and this prevents water in an environment from donating an electron to the graphene layer 12.

### Second Embodiment

A graphene structure according to a second embodiment of the present disclosure will be described. It should be noted that in this embodiment, descriptions on configurations that are the same as those of the first embodiment will be omitted in some cases.

(Configuration of Graphene Structure)

FIG. 6 is a schematic diagram showing a layer construction of a graphene structure 20 according to this embodiment. As shown in this figure, the graphene structure 20 is formed by laminating a substrate 21 and a graphene layer 22 in the stated order.

The substrate 21 is a supporting substrate of the graphene structure 20. The material, the size, and the like of the substrate 21 are not particularly limited, and a quartz substrate may be used as the material, for example. If the graphene structure 20 is expected to have optical transparency, the substrate 21 may be formed of a material which has optical transparency.

The graphene layer 22 is formed of graphene. In this embodiment also, single-layer graphene is favorable in terms of the optical transparency of the graphene structure 20 and because no delamination is caused. The graphene layer 12 is doped with a dopant. The dopant can be selected from a group consisting of, for example, nitric acid, TFSA (trifluoromethanesulfonate), gold chloride, palladium chloride, ferric chloride, silver chloride, platinum chloride, and gold iodide. The doping may be a chemical doping in which the graphene is coated with the dopant by spin coating or the like and the dopant is chemically adsorbed to the graphene. The oxidation-reduction potential of the graphene layer 22 is adjusted to a similar level to that of water by an aging process which will be described later.

The graphene structure 20 according to this embodiment is formed as described above. The graphene structure 20 can be used as an electrode of a touch panel, a solar battery, or the like.

(Production Method of Graphene Structure)

A production method of the graphene structure 20 will be described. The production method of the graphene structure 20 according to this embodiment may be the same as that of the first embodiment up to the step of doping the graphene layer 22.

After doping the graphene layer 22, the graphene layer 22 is aged. Specifically, the graphene layer 22 is aged by placing a laminated body in which the graphene layer 22 is laminated on the substrate 21 in a saturated water-vapor atmosphere at 50° C. for 1 hour. Accordingly, a carrier concentration of the dopant can be reduced until the oxidation-reduction potential of the graphene layer 22 becomes a similar level to that of water.

It should be noted that the method of aging is not limited to the above and may be the one which enables the carrier concentration to be reduced until the oxidation-reduction potential of the graphene layer 22 becomes a similar level to that of water. However, the method of immersing the laminated body into water is inappropriate because the dopant is dissolved into water. The graphene structure 20 shown in FIG. 6 can be produced as described above.

(Effect of Graphene Structure)

As described above, by the doping of the graphene layer 22, the resistance of the graphene layer 22 can be reduced in the graphene structure 20 according to this embodiment. Furthermore, because the graphene layer 22 has an oxidation-reduction potential approximately equal to that of water and this prevents water in an environment from donating an electron to the graphene layer 22, it is possible to prevent the time degradation of the conduction characteristic of the graphene layer 22.

### Third Embodiment

A graphene structure according to a third embodiment of the present disclosure will be described. It should be noted that in this embodiment, descriptions on configurations that are the same as those of the first embodiment will be omitted in some cases.

(Configuration of Graphene Structure)

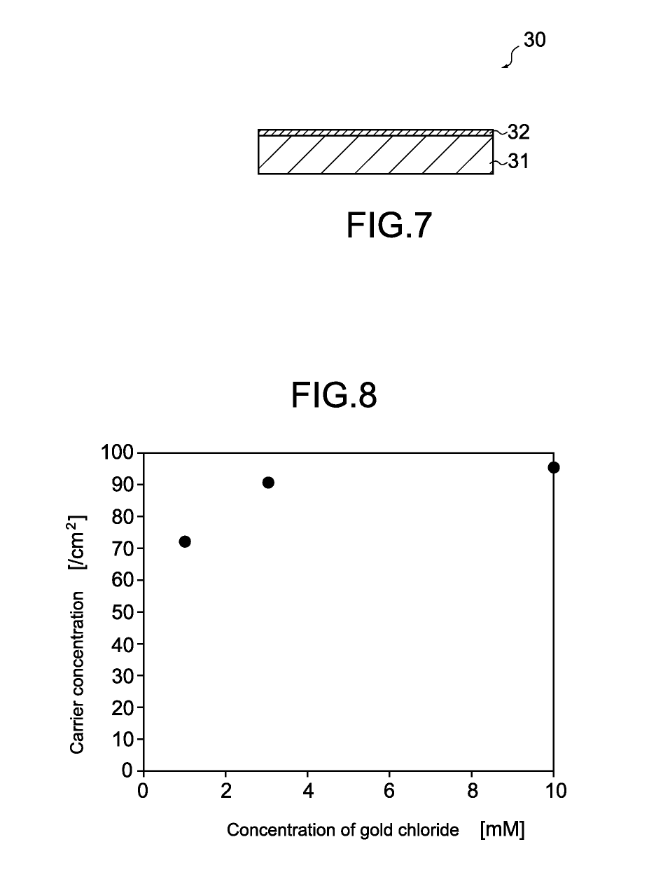

FIG. 7 is a schematic diagram showing a layer construction of a graphene structure 30 according to this embodiment. As shown in this figure, the graphene structure 30 is formed by laminating a substrate 31 and a graphene layer 32 in the stated order.

The substrate 31 is a supporting substrate of the graphene structure 30. The material, the size, and the like of the substrate 31 are not particularly limited, and a quartz substrate may be used as the material, for example. If the graphene structure 30 is expected to have optical transparency, the substrate 31 may be formed of a material which has optical transparency.

The graphene layer 32 is formed of graphene. In this embodiment also, single-layer graphene is favorable in terms of the optical transparency of the graphene structure 30 and because no delamination is caused. The graphene layer 32 is doped with a dopant. The dopant can be selected from a group consisting of, for example, nitric acid, TFSA (trifluoromethanesulfonate), gold chloride, palladium chloride, ferric chloride, silver chloride, platinum chloride, and gold iodide. The doping may be a chemical doping in which the graphene is coated with the dopant by spin coating or the like and the dopant is chemically adsorbed to the graphene.

Here, the amount of doping is adjusted so that the carrier concentration of graphene is equal to or lower than 6×10¹³/cm². It is possible to adjust the amount of doping by the method which will be described later when the graphene is doped. The carrier concentration of the graphene layer 32 is adjusted to be equal to or lower than 6×10¹³/cm² so that the graphene layer 32 may have a similar oxidation-reduction potential to that of water. It should be noted that the amount of doping is favorably adjusted so that the carrier concentration of graphene is equal to or lower than 6×10¹³/cm², particularly, equal to or larger than 4×10¹³/cm² and equal to or lower than 6×10¹³/cm², and more particularly, equal to or larger than 4.5×10¹³/cm² and equal to or lower than 5.5×10¹³/cm².

The range of values described above is calculated as follows. The carrier concentration n of graphene is determined by Ef in the following formula:

n=7.77×10¹³*Ef² (1)

where Ef represents the Fermi energy (electrochemical potential) of graphene.

The Fermi energy of graphene is represented by the following formula:

Ef=φ−4.5 eV ((p is a work function) (2)

where a work function φ of the graphene at a charge neutrality level (the carrier concentration is zero) is 4.5 eV.

When a chemical doping is performed, the work function of the graphene becomes large, so the graphene is doped. At this time, the work function of graphene becomes large up to the standard oxidation-reduction potential of the dopant (also known as the standard electrode potential E₀)+4.44 V. If the dopant is gold chloride, for example, the work function becomes large up to 5.96 eV because the standard electrode potential is 1.52 V.

Therefore, the carrier concentration of graphene becomes large up to the value determined by the following formula:

n=7.77×10¹³*(5.96−4.5)²=1.46×10¹⁴/cm² (3)

in an ideal state.

However, when the graphene is exposed in the atmosphere for a long time, the carrier concentration of the graphene is lowered down to the reduction potential of water because it reacts with water.

Since the reduction potential of water is 0.828 V, it is converted to be 5.27 eV in terms of the work function. In this case, the value of the carrier concentration of the graphene is determined by the following formula:

n=7.77×10¹³*(5.27−4.5)²=4.61×10¹³/cm² (4).

Therefore, the above-mentioned range of values including this value corresponds to the carrier concentration at which the graphene layer 32 may have a similar oxidation-reduction potential to that of water. It should be noted that the range of values does not depend on the type of the dopant.

The graphene structure 30 according to this embodiment is formed as described above. The graphene structure 30 can be used as an electrode of a touch panel, a solar battery, or the like.

(Production Method of Graphene Structure)

A production method of the graphene structure 30 will be described. The production method of the graphene structure 30 according to this embodiment may be the same as that of the first embodiment up to the step of laminating the graphene layer 32.

After laminating the graphene layer 32, graphene which forms the graphene layer 32 is doped. This can be achieved by the method as follows, for example. Specifically, gold chloride is dried in a vacuum at room temperature for 4 hours. By dissolving it into a solvent (e.g., dehydrated nitromethane), a solution at a predetermined concentration (e.g., 3 mM) (hereinafter referred to as a dopant solution) is obtained. The dopant solution is applied onto the graphene layer 32 by spin coating (2,000 rpm, 40 seconds) and dried in a vacuum. Accordingly, the graphene is doped. The graphene layer 32 can have the carrier concentration within the range of values described above by adjusting the dopant concentration in the dopant solution.

FIG. 8 is a graph showing a relationship between a concentration of gold chloride in a dopant solution and a carrier concentration right after a doping. It is considered that the favorable concentration of gold chloride is 0.2 to 0.4 mM so that the carrier concentration is equal to or lower than 6×10¹³/cm², according to this graph.

The graphene structure 30 shown in FIG. 7 may be produced as described above.

(Effect of Graphene Structure)

As described above, by the doping of the graphene layer 32, the resistance of the graphene layer 32 can be reduced in the graphene structure 30 according to this embodiment. Furthermore, it is possible to prevent the time degradation of the conduction characteristic of the graphene layer 32, because the graphene layer 32 has a similar oxidation-reduction potential to that of water and this prevents water in an environment from donating an electron to the graphene layer 32.

It should be noted that the present disclosure may employ the following configurations.

(1) A graphene structure, including:

a substrate; and

a graphene layer laminated on the substrate, formed of graphene doped with a dopant, and having a similar oxidation-reduction potential to that of water.

(2) The graphene structure according to Item (1), further including a contact layer that is formed of a material having a similar oxidation-reduction potential to that of water and comes into contact with the graphene layer.

(3) The graphene structure according to Item (1) or (2), in which the graphene layer has a carrier concentration that is equal to or lower than 6×10¹³/cm².

(4) The graphene structure according to any one of Items (1) to (3), in which the graphene layer has a carrier concentration that is equal to or larger than 4×10¹³/cm² and equal to or lower than 6×10¹³/cm².

(5) The graphene structure according to any one of Items (1) to (4), in which the graphene layer has a carrier concentration that is equal to or larger than 4.5×10¹³/cm² and equal to or lower than 5.5×10¹³/cm².

(6) A method of producing a graphene structure, including:

laminating a graphene layer formed of graphene on a substrate;

doping the graphene with a dopant; and

adjusting an oxidation-reduction potential of the graphene layer to a similar level to that of water.

(7) The method of producing a graphene structure according to Item (6), in which

the adjusting an oxidation-reduction potential of the graphene layer includes aging the graphene layer in a water-vapor atmosphere.

(8) The method of producing a graphene structure according to Item (6) or (7), in which

the adjusting an oxidation-reduction potential of the graphene layer includes laminating on the graphene layer a contact layer formed of a material having a similar oxidation-reduction potential to that of water.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A graphene structure, comprising:
a substrate; and
a graphene layer laminated on the substrate, formed of graphene doped with a dopant, and having a similar oxidation-reduction potential to that of water.

2. The graphene structure according to claim 1, further comprising a contact layer that is formed of a material having a similar oxidation-reduction potential to that of water and comes into contact with the graphene layer.

3. The graphene structure according to claim 1, wherein the graphene layer has a carrier concentration that is equal to or lower than 6×10¹³/cm².

4. The graphene structure according to claim 3, wherein the graphene layer has a carrier concentration that is equal to or larger than 4×10¹³/cm² and equal to or lower than 6×10¹³/cm².

5. The graphene structure according to claim 4, wherein the graphene layer has a carrier concentration that is equal to or larger than 4.5×10¹³/cm² and equal to or lower than 5.5×10¹³/cm².

6. A method of producing a graphene structure, comprising:
laminating a graphene layer formed of graphene on a substrate;
doping the graphene with a dopant; and
adjusting an oxidation-reduction potential of the graphene layer to a similar level to that of water.

7. The method of producing a graphene structure according to claim 6, wherein
the adjusting an oxidation-reduction potential of the graphene layer includes aging the graphene layer in a water-vapor atmosphere.

8. The method of producing a graphene structure according to claim 6, wherein
the adjusting an oxidation-reduction potential of the graphene layer includes laminating on the graphene layer a contact layer formed of a material having a similar oxidation-reduction potential to that of water.
